(19) United States
(12) Patent Application Publication
(10) Pub. No.: US 2013/0339158 A1
(43) Pub. Date: Dec. 19, 2013

(54) DETERMINING LEGITIMATE AND MALICIOUS ADVERTISEMENTS USING ADVERTISING DELIVERY SEQUENCES

(71) Applicants: Yinglian Xie, Cupertino, CA (US); Fang Yu, Sunnyvale, CA (US); Zhou Li, Bloomington, IN (US); Xiaofeng Wang, Bloomington, IN (US)

(72) Inventors: Yinglian Xie, Cupertino, CA (US); Fang Yu, Sunnyvale, CA (US); Zhou Li, Bloomington, IN (US); Xiaofeng Wang, Bloomington, IN (US)

(73) Assignee: Microsoft Corporation, Redmond, WA (US)

(21) Appl. No.: 13/527,586

(22) Filed: Jun. 19, 2012

(51) Int. Cl. G06Q 30/02

(52) U.S. Cl. 705/14.73; 705/14.4

(57) ABSTRACT

Known legitimate and malicious display advertisements are selected, and the ordered sequence of entities involved in the delivery of each display advertisement is observed and used to generate advertisement delivery sequences. The entities include the various servers, publishers, and advertising networks that are involved in the delivery of a display advertisement. Attributes of the entities in each sequence are determined and used to generate a set of rules that identify a display advertisement as legitimate or malicious based on the attributes of the advertising delivery sequence associated with the delivery of the display advertisement. The generated rules are used to identify possible malicious advertisements, and to identify one or more sources of malicious display advertisements.

### BACKGROUND

Online advertising is an increasing source of revenue on web pages. Compared to traditional advertising media, online advertising is more convenient and cost effective. One can easily set up an account with major advertisers and push advertisements to a variety of web pages. Unfortunately, malicious users, such as hackers and con artists, have also found web advertisements to be a low cost and highly effective means to conduct malicious and fraudulent activities, which are broadly referred to herein as malvertising.

Both industry and academia have been working on this threat, typically through inspecting advertisements to detect malicious content. However, malicious advertisements often use obfuscation and code packing techniques to evade detection. Further complicating the situation is the pervasiveness of advertising syndication, a business model in which an advertising network maintains advertisements submitted by advertisers on its servers, and sells and resells the spaces the network acquires from publishers to other advertising networks and advertisers.

### SUMMARY

Known legitimate and malicious display advertisements are selected, and the ordered sequence of entities involved in the delivery of each display advertisement is observed and used to generate advertising delivery sequences. The entities include the various servers, publishers, and advertising networks that are involved in the delivery of a display advertisement. Attributes of the entities in each sequence are determined and used to generate a set of rules that identify a display advertisement as legitimate or malicious based on the attributes of the advertising delivery sequence associated with the delivery of the display advertisement. The generated rules are used to identify possible malicious display advertisements, and to identify one or more sources of malicious display advertisements.

In some implementations, an identifier of a web page is received by a computing device. The web page is associated with at least one display advertisement. An advertising delivery sequence associated with the delivery of the at least one display advertisement is determined by the computing device. The advertising delivery sequence includes an ordered sequence of entities involved in the delivery of the at least one display advertisement. Based on the advertising delivery sequence, whether the at least one display advertisement is a malicious advertisement is determined by the computing device. If the at least one display advertisement is a malicious advertisement, an alert is generated at the at least one computing device.

In some implementations, advertising delivery sequences are received at a computing device. Each advertising delivery sequence is associated with the delivery of a display advertisement to a web page, and each advertising delivery sequence comprises an ordered sequence of nodes, and each node is associated with an entity. A first set of advertising delivery sequences of the advertising delivery sequences that are associated with display advertisements that are malicious is identified by the computing device. A second set of advertising delivery sequences of the advertising delivery sequences that are associated with display advertisements that are legitimate is determined by the computing device. A set of rules is generated based on the first set of advertising delivery sequences and the second set of advertising delivery sequences. An advertising delivery sequence is received by the computing device. The received advertising delivery sequence is not in the plurality of advertising delivery sequences. Whether the received advertising delivery sequence is legitimate or malicious is determined based on the generated set of rules by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, these embodiments are not limited to the specific methods and instrumentalities disclosed. In the drawings:

FIG. 1 is an illustration of an example environment for determining legitimate and malicious display advertisements;

FIG. 2 is an illustration of an advertising trust engine;

FIG. 3 illustrates an operational flow diagram of an implementation of a method for determining if a display advertisement is malicious;

FIG. 4 illustrates an operational flow diagram of an implementation of a method for determining if an advertising delivery sequence is legitimate or malicious; and

FIG. 5 shows an exemplary computing environment.

### DETAILED DESCRIPTION

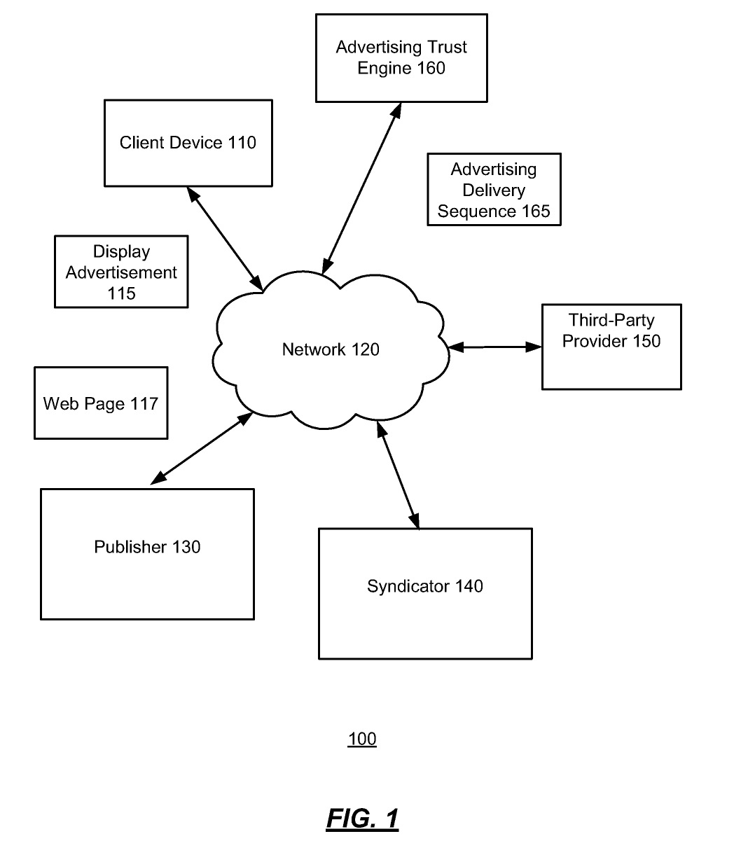

FIG. 1 is an illustration of an example environment 100 for determining legitimate and malicious advertisements. A client device 110 may communicate with one or more publishers 130 through a network 120. The client device 110 may be configured to communicate with the publishers 130 to request and receive one or more web pages 117. The network 120 may be a variety of network types including the public switched telephone network (PSTN), a cellular telephone network, and a packet switched network (e.g., the Internet).

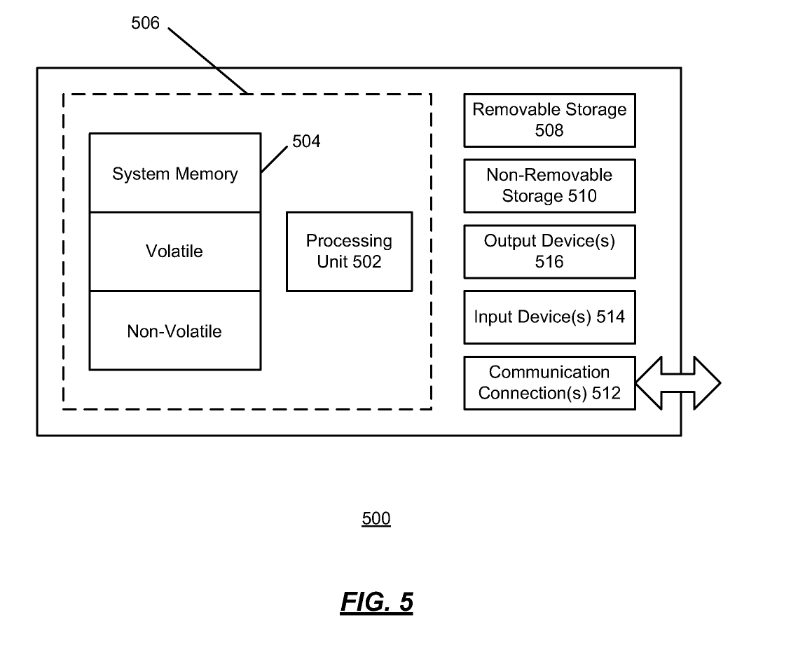

In some implementations, the client device 110 may include a desktop personal computer, workstation, laptop, PDA, smart phone, cell phone, or any WAP-enabled device or any other computing device capable of interfacing directly or indirectly with the network 120. The client device 110 may run an HTTP client, e.g., a browsing program, such as MICROSOFT INTERNET EXPLORER or other browser, or a WAP-enabled browser in the case of a cell phone, PDA or other wireless device, or the like. The client device 110 may be implemented using a general purpose computing device such as the computing device 500 illustrated in FIG. 5, for example.

In some implementations, the web page 117, when displayed to a user of the client device 110, may include one or more advertising tags that cause one or more display advertisements 115 to be requested and displayed as part of the web page 117. The tags may be iframes or JavaScript code, for example. The display advertisements 115 may include a variety of well-known display advertisements such as banner advertisements, for example. The display advertisements 115 may include text, images, and videos, for example.

The advertising tags may cause the client device 110 to request one or more display advertisements 115 from one or more third-party providers 150. The third-party providers 150 may include advertising networks, and may select a display advertisement 115 to provide to the client device 110 based on information provided by the advertising tags. For example, a publisher 130 may have contracted with the third-party provider 150 to provide display advertisements 115 that are displayed on the web pages 117 of the publisher 130.

Alternatively or additionally, the advertising tags may cause the client device 110 to request advertisements 115 from one or more syndicators 140. The syndicators 140 may be advertising syndicators, and rather than providing one or more display advertisements 115 to the client device 110, the syndicators 140 may provide the client device 110 with additional tags or code that causes the client device 110 to request a display advertisement from another third-party provider 150, or even another syndicator 140. For example, a publisher 130 may sell advertising rights for a web page 117 to a syndicator 140. The syndicator 140 may then sell the rights to one or more third-party providers 150, or even one or more other syndicators 140.

As may be appreciated, the sequence of third-party providers 150 and/or syndicators 140 that are involved in the delivery of a display advertisement 115 provide many opportunities for malicious users to provide one or more malicious display advertisements 115 or so called “malvertisements.” Examples of malvertisements include what are referred to as drive-by-download attacks, phishing attacks, and click-fraud attacks.

Drive-by-download attacks exploit the vulnerabilities of browsers or plug-ins such as Flash and JavaScript. Once a user loads a web page 117 with an infected script, the browser automatically downloads and installs malware or other malicious programs to the client device 110.

Phishing attacks trick the users of the client devices into providing personal information. For example, a display advertisement 115 may be displayed to a user that makes a user think that they have been infected with a virus or malware. The user is then tricked into disclosing financial or password information to remove the purported virus or malware.

Click-fraud attacks may hijack the client devices in order to make profit from fraudulent click traffic. For example, the browser of a client device 110 may be used to generate fraudulent clicks on a display advertisement 115 to generate click revenue, or to deplete the advertising budget of a competitor.

In order to identify and/or prevent malvertising, an advertising trust engine 160 is provided in the environment 100. The advertising trust engine 160 may be implemented using a general purpose computing device such as the computing device 500 illustrated with respect to FIG. 5. In addition, all or some portion of the advertising trust engine 160 may be implemented as part of the client device 110. For example, the advertising trust engine 160 may be a plug-in or other component of a browser associated with the client device 110.

In some implementations, the advertising trust engine 160 may determine if a requested display advertisement 115 is legitimate (i.e., not malvertising) or malicious (i.e., malvertising). If the display advertisement 115 is legitimate, then the display advertisement 115 may be displayed or provided to the client device 110. If the display advertisement 115 is malicious, then the display advertisement 115 may be discarded and/or an alert may generated for the client device 110. A user of the client device 110 may then determine whether or not to display the display advertisement 115.

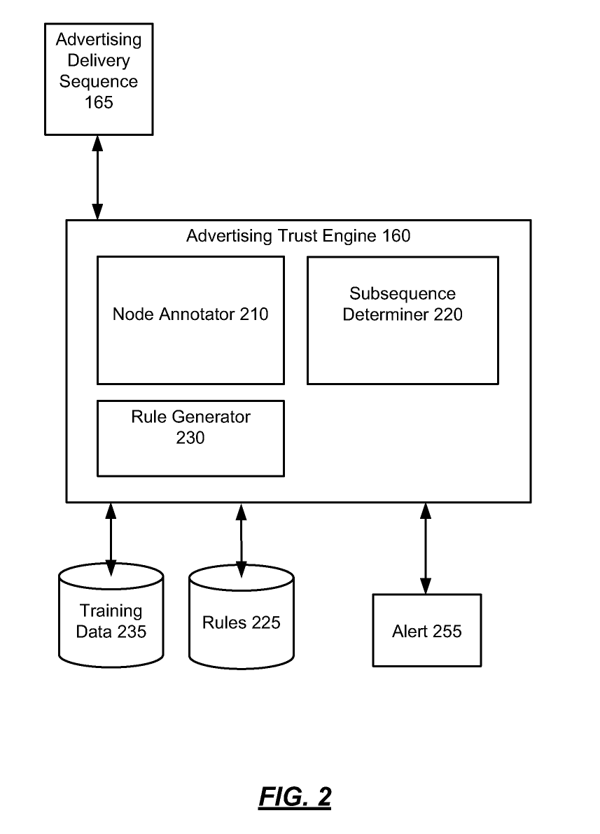

As will be described further with respect to FIG. 2, the advertising trust engine 160 may determine if a display advertisement 115 is legitimate or malicious based on an advertising delivery sequence 165 associated with the display advertisement 115. In some implementations, the advertising delivery sequence 165 may be an ordered representation of the sequence of the entities that are contacted or otherwise involved in the delivery of the display advertisement 115. The advertising delivery sequence 165 may include a node for each of the entities. The entities may include servers of other computing devices associated with one or more publishers 130, syndicators 140, and third-party providers 150. In addition, the entities may include servers or other computing devices associated with one or more malicious entities (i.e., malware providers).

Before the client device 110 downloads a display advertisement 115 for placement in a web page 117, the client device may use the advertising trust engine 160 to determine if the display advertisement 115 is legitimate or malicious. To make the determination, the advertising trust engine 160 may determine the advertising delivery sequence 165 for the display advertisement 115. For example, the trust engine 160 may determine the advertising delivery sequence 165 using the advertising tags embedded in the web page 117, and following the sequence of entities that are involved in the providing of the display advertisement 115. The resulting advertising delivery sequence 165 may then be classified based on the set of previously determined advertising delivery sequences 165 of known legitimate or malicious display advertisements 115. The advertising trust engine 160 may then determine if the display advertisement 115 is legitimate or malicious. If the display advertisement 115 is determined to be malicious or malvertising, the advertising trust engine 160 for example may trigger an alert to a user of the client device 110, may prevent the display advertisement 115 from being displayed with the web page 117, or may further monitor the publisher 130 associated with the web page 117 for malvertising.

FIG. 2 is an illustration of the advertising trust engine 160. The advertising trust engine 160 may include several components including, but not limited to, a node annotator 210, a subsequence determiner 220, and a rule generator 230. Some or all of the components of the advertising trust engine 160 may be implemented by one or more computing devices such as the computing device 500 illustrated with respect to FIG. 5.

The advertising trust engine 160 may receive and/or collect training data 235. The training data 235 may include advertising delivery sequences 165 that have been collected and are known to be either associated with legitimate display advertisements or malicious display advertisements. The training data 235 may have been collected and generated by the advertising trust engine 160, or may have been collected and generated by one or more other sources.

The node annotator 210 may generate annotations for one or more nodes, or node pairs of advertising delivery sequences 165 in the training data 235. The annotations may be based on characteristics of the entities represented by the nodes that have been determined to be predictive of the trustworthiness or untrustworthiness (i.e., legitimate or malicious) of a display advertisement 115. In some implementations, the annotations may include what are referred to herein as frequency attributes, role attributes, domain registration attributes, and URL (Uniform Resource Locator) attributes. Other attributes may be supported.

The frequency attributes are attributes that are based on the overall popularity of an entity, or popularity of a consecutive entity pair, among the various entities represented in the training data 235. Entities that are popular are less likely to be malicious or compromised entities because the majority of entities in advertising delivery sequences 165 are legitimate. Similarly, popular consecutive entity pairs may represent common publisher 130/syndicator 140/third-party provider 150 relationships, and may also indicate legitimate entities. Thus, a high frequency attribute for an entity or entity pair is likely to be a legitimate entity or entity pair, while a low frequency attribute for an entity or entity pair is likely to be a malicious entity or entity pair.

The role attributes are attributes that are based on whether the entity associated with a node has a known role related to advertising; for example, whether the entity is a known publisher 130, syndicator 140, or third-party provider 150. Entities that are known are likely to be well established and therefore legitimate since many malicious entities only exist for a short time or may be hijacked entities that are not otherwise known to be related to advertising. In some implementations, the role of an entity associated with a node may be determined by the node annotator 210 using sources such as EasyList and EasyPrivacy, for example.

The domain registration attributes are attributes that are based on the domain registration and expiration dates associated with an entity corresponding to a node. More specifically, the attribute may be a measure of the difference between the registration time of a domain and the expiration time. Because domain registration has an associated cost, most untrustworthy entities have a domain with short amount of time between its registration and expiration. Entities with domains with less than a year between its registration and expiration may receive a low domain registration attribute by the node annotator 210, while entities with domains having more than a year may receive a higher domain registration attribute.

The URL attributes are attributes that are based on the URL of the entity associated with a node. The node annotator 210 may determine the URL attributes by matching one or more regular expressions or patterns associated with URLs of untrustworthy entities against the URL of an entity. For example, URLs that include the substring “co.cc” may be associated with malicious entities.

The subsequence determiner 220 may generate, or collect, subsequences from the advertising delivery sequences 165 of the training data 235. In some implementations, the subsequence determiner 220 may generate the possible subsequences of a selected length. For example, the selected length may be three. Other lengths may also be used.

For example, an advertisement delivery sequence 165 of length five may include an ordered sequence of five nodes that represent the entities A, B, C, D, and E. The advertising delivery sequence 165 may be represented as A→B→C→D→E and may be used to generate three subsequences by the subsequence determiner 220. The subsequences include A→B→C, B→C→D, and C→D→E. Where an advertising delivery sequence 165 has less than three nodes, the subsequence determiner 220 may include a null node in the generated subsequence.

The rule generator 230 may use the annotated subsequences generated by the node annotator 210 and the subsequence determiner to generate rules 225 that may be used to determine if a display advertisement 115 is legitimate or malicious based on annotated nodes of subsequences of the advertising delivery sequence 165 associated with the display advertisement 115. Malicious or untrustworthy entities typically are close to each other in an advertising delivery sequence 165. For example, a malicious user may compromise a third-party provider 150 and may cause it to redirect a client device 110 to an advertising server that is also under the malicious user's control.

In some implementations, the rules 225 may be derived by constructing a decision tree that may be generated by the rule generator 230. In some implementations, other methods such as machine learning or neural networks may be used to generate the rules 225.

With respect to generating the decision tree, in some implementations, the rule generator 230 may first generate a decision tree that operates on subsequences of annotated notes. The tree may include a leaf for each possible combination of attribute values for the subsequences. In some implementations, in order to reduce the number of leaves, the rule generator 230 may select the leaves of the tree that are able to correctly identify at least one malicious advertisement from the training data 235 based on an associated subsequence. These leaves may then be ranked in ascending order based on the number of known legitimate advertisements from the training data 235 that they incorrectly identify as malicious. Some subset of the leaves that are ranked the highest may then be left in the decision tree as the rules 225. Alternatively or additionally, attributes that are found to be agnostic (i.e., not predictive) may be further used to remove leaves from the decision tree.

The advertising trust engine 160 may use the generated rules to evaluate the legitimacy of a received advertising delivery sequence 165. In some implementations, the advertising delivery sequence 165 may be provided by a client device 110 for the advertising trust engine 160 to evaluate. In other implementations, the advertising trust engine 160 may crawl web pages 117 associated with publishers 130 looking for advertising delivery sequences 165 that are malicious. Publishers 130 with untrustworthy advertising delivery sequences 165 may be flagged for further scrutiny, and one or more malicious entities may be identified.

The node annotator 210 may annotate the nodes of the advertising delivery sequence 165, and the subsequence determiner 220 may determine one or more node subsequences from the advertising delivery sequence 165. The advertising trust engine 160 may then determine if any of the subsequences trigger or match any of the rules 225. If so, the advertising trust engine 160 may determine that the display advertisement 115 associated with the advertising delivery sequence is not a legitimate display advertisement and may generate an alert 255.

Depending on the implementation, the alert 255 may be provided to the client device 110 that provided the advertising delivery sequence 165 or display advertisement 115. The client device 110 may provide the alert 255 to a user, or may refuse to display the display advertisement 115 with the web page 117. If the advertising delivery sequence 165 was provided in response to the advertising trust engine 160 crawling the web pages 117 of a publisher 130, then the advertising trust engine 160 may further monitor and analyze the advertising delivery sequences 165 of advertisements associated with web pages 117 of the publisher 130. The results of the monitoring may be used to update the rules 225.

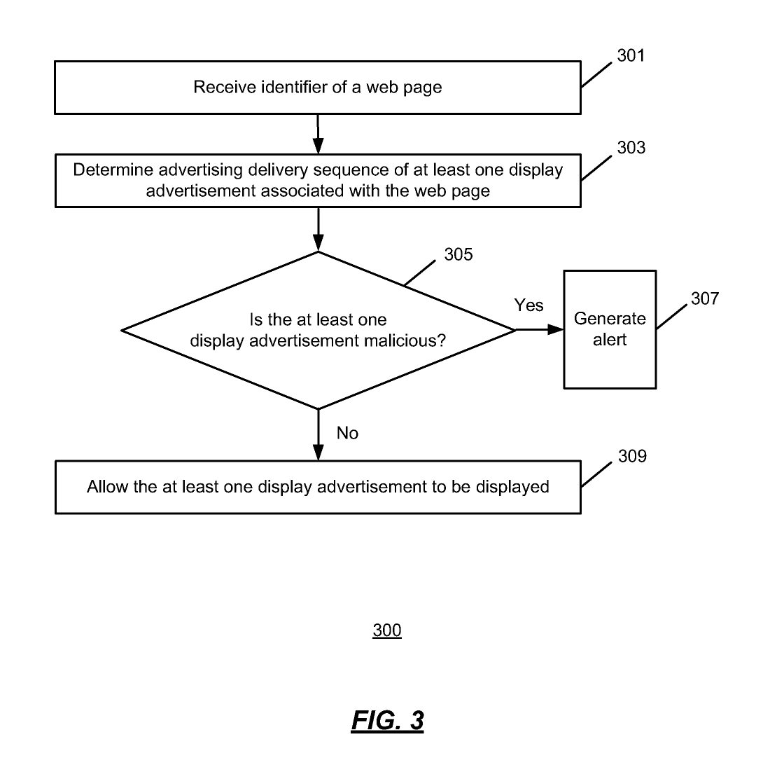

FIG. 3 illustrates an operational flow diagram of an implementation of a method 300 for determining if a display advertisement is malicious. The method 300 may be implemented by the advertising trust engine 160, for example.

An identifier of a web page is received at 301. The identifier of the web page 117 may be received by the advertising trust engine 160. In some implementations, the identifier of the web page 117 may be received by the advertising trust engine 160 from a client device 110. For example, the client device 110 may have received the web page 117 and may request that the advertising trust engine 160 determine the trustworthiness of one or more display advertisements in the web page 117 (i.e., whether they are malicious or legitimate). Alternatively or additionally, the advertising trust engine 160 may crawl the web pages associated with one or more publishers 130, and the identified web page 117 may have been received by the advertising trust engine 160 as a result of the crawl.

An advertising delivery sequence of at least one display advertisement associated with the web page is determined at 303. The advertising delivery sequence 165 may be determined for at least one display advertisement 115 associated with the web page 117 by the advertising trust engine 160. In some implementations, the advertising delivery sequence 165 may be an ordered sequence of the entities involved in the delivery of at least one display advertisement 115. The sequence 165 may include a node representing each entity. The entities may be publishers 130, syndicators 140, and third-party providers 150, for example. The entities may also include one or more malicious or legitimate entities.

A determination is made as to whether the at least one display advertisement is malicious at 305. The determination may be made by the advertising trust engine 160 using the advertising delivery sequence 165 and one or more rules 225. In some implementations, a subsequence determiner 220 of the advertising trust engine 160 may generate a plurality of node subsequences of a specified length from the advertising delivery sequence 165. The specified length may be three, for example. If any of the subsequences matches or triggers a rule from the rules 225, then the advertising trust engine 160 may determine that the at least one display advertisement 115 is malicious. If no subsequence matches or triggers a rule, then the advertising trust engine 160 may determine that the at least one advertisement 115 is legitimate.

In some implementations, the node annotator 210 of the advertising trust engine 160 may annotate the nodes of each of the subsequences. The annotations may be based on characteristics of the entities represented by each node and may include frequency attributes, role attributes, domain registration attributes, and URL attributes. The determination of whether a subsequence matches or triggers a rule from the rules 225 may be based on the attributes determined for the nodes in the subsequence.

If the display advertisement is malicious then the method 300 may continue at 307. Otherwise, the display advertisement 115 is legitimate and the method 300 may continue at 309.

An alert is generated at 307. The alert 255 may be generated by the advertising trust engine 160. In some implementations, the alert 255 may be provided to the client device 110 that provided the identifier of the web page 117. The client device 110 may then determine not to display at least one display advertisement 115 along with the web page 117.

In some implementations, in response to the alert 255, the advertising trust engine 160 may determine to monitor other web pages associated with the publisher 130 of the identified web page 117. The monitoring may determine malicious display advertisements 115 associated with the web pages of the publisher 130, and the advertising trust engine 160 may use the advertising delivery sequences 165 of the malicious display advertisements to update the rules 225. The advertising trust engine 160 may further help the publisher 130 remove the determined malicious display advertisements 115.

The at least one display advertisement is allowed to be displayed at 309. The at least one display advertisement 115 may be displayed along with the identified web page 117 by the client device 110. In implementations where the advertising trust engine 160 crawls publisher 130 web pages 117 looking for malicious display advertisements 115, the advertising trust engine 160 may receive a new indication of a web page 117.

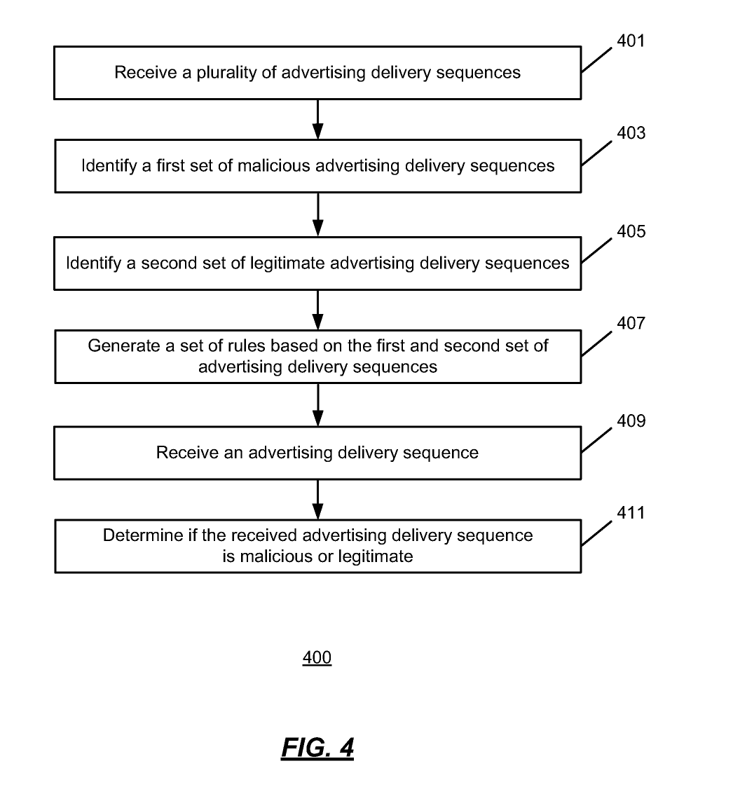

FIG. 4 illustrates an operational flow diagram of an implementation of a method 400 for determining if an advertising delivery sequence is legitimate or malicious. The method 400 may be implemented by the advertising trust engine 160.

A plurality of advertising delivery sequences is received at 401. The plurality of advertising delivery sequences 165 may be received by the advertising trust engine 160. Each advertising delivery sequence 165 may be associated with a display advertisement 115 and may include a plurality of ordered nodes. Each node may represent an entity involved in the delivery of the display advertisement 115. The plurality of advertising sequences 165 may comprise the training data 235.

A first set of malicious advertising delivery sequences is identified at 403. The first set of malicious advertising delivery sequences may be identified from the plurality of advertising delivery sequences 165 by the advertising trust engine 160. The malicious advertising delivery sequences may be the advertising sequences 165 that are associated with display advertisements 115 that are malicious.

A second set of legitimate advertising delivery sequences is identified at 405. The second set of legitimate advertising delivery sequences may be identified from the plurality of advertising delivery sequences 165 by the advertising trust engine 160. The legitimate advertising delivery sequences may be the advertising sequences 165 that are associated with display advertisements 115 that are legitimate (i.e., not known to be malvertisements).

A set of rules is generated based on the first and second advertising delivery sequences at 407. The set of rules may be generated by the rule generator 230 of the advertising trust engine 160. In some implementations, the set of rules may comprise the rules 225 and may be generated by the rule generator 230 by generating a decision tree based on the first and second set of rules. The rules 225 may be rules that correctly identify one or more advertising delivery sequences 165 from the first set as being malicious, while having a false positive rate with respect to the advertising delivery sequences 165 from the second set that is below a threshold false positive rate.

In some implementations, the rules 225 may be generated using one or more annotated node subsequences. The node annotator 210 may annotate each node of the node subsequence, and the annotated nodes of the subsequences may be used by the rule determiner 230 to generate the rules 225.

An advertising delivery sequence is received at 409. The advertising delivery sequence 165 may be received by the advertising trust engine 160. The received advertising delivery sequence 165 may be associated with a display advertisement 115 whose advertising delivery sequence 165 was not part of the training data 235.

A determination is made as to whether the advertising delivery sequence is legitimate or malicious at 411. Whether the advertising delivery is legitimate or malicious may be determined by the advertising trust engine 160 using the rules 225. In some implementations, the subsequence determiner 220 and the node annotator 210 may generate a plurality of annotated subsequences from the advertising deliver sequence 165, and may determine if any of the annotated subsequences match any of the rules 225. If so, the advertising delivery sequence 165 is malicious, and the advertisement 115 associated with the sequence 165 may be malvertising.

FIG. 5 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network personal computers, minicomputers, mainframe computers, embedded systems, distributed computing environments that include any of the above systems or devices, and the like.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving an identifier of a web page by a computing device, the web page associated with at least one display advertisement;
determining an advertising delivery sequence associated with the delivery of the at least one display advertisement by the computing device, wherein the advertising delivery sequence comprises an ordered sequence of entities involved in the delivery of the at least one display advertisement;
determining, based on the advertising delivery sequence, if the at least one display advertisement is an malicious display advertisement by the computing device; and
if at least one display advertisement is a malicious display advertisement, generating an alert at the computing device.

2. The method of claim 1, wherein the web page is associated with a publisher, and further comprising:
if the at least one display advertisement is a malicious display advertisement, monitoring one or more additional web pages associated with the publisher.

3. The method of claim 1, wherein determining an advertising delivery sequence comprises determining a node for each entity involved in the delivery of the at least one display advertisement, and determining a plurality of attributes for each node based on the entity associated with each node.

4. The method of claim 3, wherein the attributes comprise at least of frequency attributes, role attributes, domain registration attributes, or URL attributes.

5. The method of claim 3, further comprising collecting a plurality of node subsequences of a selected length from the advertising delivery sequence.

6. The method of claim 5, wherein the selected length is three.

7. The method of claim 5, wherein determining, based on the advertising delivery sequence, if at least one display advertisement is a malicious display advertisement further comprises:
determining if any of the collected node subsequences is a malicious node sequence; and
determining that the at least one display advertisement is a malicious advertisement if any of the collected node sequences is a malicious node subsequence.

8. A method comprising:
receiving a plurality of advertising delivery sequences at a computing device, wherein each advertising delivery sequence is associated with the delivery of a display advertisement to a web page and each advertising delivery sequence comprises an ordered sequence of nodes and each node is associated with an entity;
identifying a first set of advertising delivery sequences of the plurality of advertising delivery sequences that are associated with display advertisements that are malicious by the computing device;
identifying a second set of advertising delivery sequences of the plurality of advertising delivery sequences that are associated with display advertisements that are legitimate by the computing device;
generating a set of rules based on the first set of advertising delivery sequences and the second set of advertising delivery sequences by the computing device;
receiving an advertising delivery sequence by the computing device, wherein the received advertising delivery sequence is not in the plurality of advertising delivery sequences; and
determining if the received advertising delivery sequence is legitimate or malicious based on the generated set of rules by the computing device.

9. The method of claim 8, further comprising updating the set of rules based on the received advertising delivery sequence.

10. The method of claim 8, wherein generating the set of rules based on the first set of advertising delivery sequences and the second set of advertising delivery sequences comprises:
for each advertising delivery sequence, determining a plurality of attributes for each node of the advertising delivery sequence based on the entity associated with the node; and
generating the set of rules based on the attributes of the adverting delivery sequences.

11. The method of claim 10, further comprising:
for each advertising delivery sequence, determining a plurality of node subsequences of a selected length from the advertising delivery sequence; and
generating the set of rules based on the attributes and node subsequences of the adverting delivery sequences.

12. The method of claim 10, wherein the attributes comprise at least one of frequency attributes, role attributes, domain registration attributes, or URL attributes.

13. The method of claim 10, wherein determining if the received advertising delivery sequence is legitimate or malicious based on the generated set of rules comprises:
determining a plurality of attributes for each node of the received advertising delivery sequence based on the entity associated with the node;
determining a plurality of node subsequences of a selected length from the received advertising delivery sequence; and
determining if the received advertising delivery sequence is legitimate or malicious based on the generated set of rules, the plurality of attributes associated with each node of the received advertising delivery sequence, and the plurality of node subsequences of the received advertising delivery sequence.

14. The method of claim 13, wherein the selected length is three.

15. A system comprising:
at least one computing device; and
an advertising trust engine adapted to:
receive an advertising delivery sequence associated with the delivery of at least one display advertisement, wherein the advertising delivery sequence comprises an ordered sequence of nodes and each node represents an entity involved in the delivery of the at least one display advertisement;
determine a plurality of attributes for each node based on the entity represented by each node;
determine a plurality of node subsequences of a selected length from the advertising delivery sequence; and
determine, based on the plurality of node subsequences and the plurality of attributes determined for each node, if the at least one display advertisement is an malicious advertisement.

16. The system of claim 15, wherein the plurality of attributes comprise at least one of frequency attributes, role attributes, domain registration attributes, or URL attributes.

17. The system of claim 15, wherein the advertising trust engine is further adapted to receive a set of rules, and determining, based on the plurality of node subsequences and the plurality of attributes determined for each node, if the at least one display advertisement is an malicious advertisement comprises determining, based on the plurality of node subsequences, the plurality of attributes determined for each node, and the set of rules, if the at least one display advertisement is an malicious advertisement.

18. The system of claim 17, wherein determining, based on the plurality of node subsequences, the plurality of attributes determined for each node, and the set of rules, if the at least one display advertisement is an malicious advertisement comprises:
determining if a node subsequence of the plurality of node subsequences and attributes of the nodes in the node subsequence matches any rule of the set of rules; and
if so, determining that the at least one display advertisement is an malicious advertisement.

19. The system of claim 15, wherein the selected length is three.

20. The system of claim 15, wherein the at least one display advertisement is associated with a web page from a publisher, and the advertising trust engine is further adapted to:
if the at least one display advertisement is an malicious advertisement, monitor one or more additional web pages associated with the publisher.
